(19) United States
(12) Patent Application Publication
(10) Pub. No.: US 2022/0095434 A1
(43) Pub. Date: Mar. 24, 2022

(54) SYSTEM AND METHOD FOR FOG DETECTION AND VEHICLE LIGHT CONTROL

(71) Applicant: Optimum Semiconductor Technologies Inc., Tarrytown, NY (US)

(72) Inventors: Keyi LI, Tarrytown, NY (US); Sabin Daniel IANCU, Pleasantville, NY (US); John GLOSSNER, Nashua, NH (US); Beinan WANG, White Plains, NY (US); Samantha MURPHY, Nashua, NH (US)

(73) Assignee: Optimum Semiconductor Technologies Inc., Tarrytown, NY (US)

(21) Appl. No.: 17/433,673

(22) PCT Filed: Feb. 21, 2020
(86) PCT No.: PCT/US2020/019338

§ 371 Date: Aug. 25, 2021

Related U.S. Application Data
(60) Provisional application No. 62/810,705, filed on Feb. 26, 2019.

(51) Int. Cl. H05B 47/105; G06T 7/90; H05B 45/20; B60Q 1/20

(52) U.S. Cl. CPC H05B 47/105; G06T 7/90; H05B 45/20; B60Q 2300/30; G06T 2207/20084; G06T 2207/30252; G06T 2207/30192; B60Q 1/20

(57) ABSTRACT

An intelligent light system installed on a motor vehicle includes a light source to provide illumination for the motor vehicle, wherein a wavelength of a light beam generated by the light source is adjustable, a plurality of sensors for capturing sensor data of an environment surrounding the motor vehicle, and a processing device to receive the sensor data captured by the plurality of sensors, provide the sensor data to a neural network to determine a first state of the environment, and issue a control signal to adjust the wavelength of the light beam based on the determined first state of the environment.

### CROSS-REFERENCE TO RELATED APPLICATION

This application claims priority to U.S. Provisional Application 62/810,705 filed Feb. 26, 2019, the content of which is incorporated by reference in its entirety.

### TECHNICAL FIELD

The present disclosure relates to the lighting system of a vehicle, and in particular, to a system and method that can detect the fog conditions using a neural network and based on the detected fog condition, control the color or wavelength of the lights of the vehicle based on the detected fog conditions.

### BACKGROUND

The lighting system of a motor vehicle may include light lamps (“lights”) and control devices that operate the lights. The lights may include headlights, tail lights, fog lights, signal lights, brake lights, and hazard lights. The headlights are commonly mounted on the front end of the motor vehicle and when turned on, illuminate the road in front of the motor vehicle in low visibility conditions such as, for example, in the dark or in the rain. The headlights may include a high beam to shine on the road and provide notice to drivers of the approaching vehicles from the opposite direction. The headlights may also include a low beam to provide adequate light distribution without adversely affecting the drivers from the opposite direction. The tail lights are red lights mounted on the rear of the motor vehicle to help drivers traveling behind to identify the motor vehicle. Fog lights commonly turned on during fog conditions may be mounted in the front of the motor vehicle at a location lower than the headlights to prevent the fog light beams from refracting on the fog and glaring back to the driver.

Signal lights (also known as turn signals) are mounted in the front and the rear of the motor vehicle used by the driver to indicate the turn directions of the motor vehicle. Brake lights located to the side of rear end of the motor vehicle are used to indicate braking actions that slow down or stop the motor vehicle. Hazard lights located in the front and the rear of the motor vehicle, when turned on, may indicate that the motor vehicle is driven with impairments such as a mechanical problem or distress conditions.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a car including an intelligent light system according to an implementation of the present disclosure.

FIG. 2A illustrates a LED light system according to an implementation of the present disclosure.

FIG. 2B illustrates a LED light system including discrete LEDs at different wavelengths according to an implementation of the present disclosure.

FIG. 3 illustrates a flowchart of a method to control a light system according to an implementation of the disclosure.

FIG. 4 is a decision tree for determining the wavelength of the light system according to an implementation of the disclosure.

FIG. 5 illustrates a flowchart of a method to control a light system according to an implementation of the disclosure.

FIG. 6 depicts a block diagram of a computer system operating in accordance with one or more aspects of the present disclosure.

### DETAILED DESCRIPTION

The motor vehicle can be driven by a driver (referred to as the driver mode). Alternatively, the motor vehicle can be autonomous or self-driving (referred to as the self-driving mode). In either driving mode, the lights of the motor vehicle may provide illumination on the road and signals its presence to other vehicles or pedestrians nearby in low visibility situations. The low visibility situations may include the dark or fog conditions. The lights may allow the driver of a regular vehicle to clearly see the road ahead or alternatively, allow the image sensor of the autonomous vehicle to capture clear images of the road ahead.

Fog is composed of cloud of water droplets or ice crystals suspended in the air above but close to the earth surface. A blanket of fog may adversely affect the visibility of the driver or the quality of images captured by the image sensors mounted on an autonomous vehicle. The density of the fog may determine the visibility level that the driver (or image sensor) may face. The concentration of the water droplets in the air may determine the fog density thus the visibility level. For example, the visibility level in a blanket of fog may range from the appearance of haze to almost zero visibility in very heavy fog.

Lights may help improve visibility in a fog condition. Lights that deployed in fog conditions may include the headlights and the fog lights. In current implementations, in a fog condition, the driver may turn on the headlight and/or the fog lights to improve the visibility for the driver, and in the meantime, enhance the motor vehicle profile to facilitate other drivers to notice the motor vehicle. Although current implementations of lights may help improve the visibility, these implementations do not take into account the density of the fog or the driving mode (i.e., whether the vehicle is in the driver mode or the self-driving mode). Thus, the high-beam headlights of identical intensity and color or fog lights of identical intensity and color may be turned on in different fog conditions. This, however, may not be optimal. While driving on the road in a fog, the density of the fog may vary as the vehicle moves along the road. Different fog densities and different driving modes may require different types of lights to achieve the optimal illumination.

The present disclosure recognizes that lights of the motor vehicle are commonly noncoherent light sources. Two lights are coherent if they have a constant phase shift. The propagation of the light in fog may be affected by the density of the fog and the wavelengths of the light. When light propagates through fog, the light waves may interact with the content (e.g., water droplets) of the fog, resulting scattering of the light and attenuation of light intensity. The attenuation of light intensity may be represented using Beer-Lambert-Bouguer law as

$$I / {I}_{0} = τ = {e}^{- ax} ,$$

where I₀ represents the initial light intensity (i.e., at the light source), l represents the light intensity having traveled a distance x in a fog having a density of a, and τ represents the transmittance of light. Thus, the intensity of the light is attenuated through the fog according to an exponential relation.

When light travels through a medium, the intensity of the light may be attenuated due to absorption and scattering with the content of the medium. In fog, the absorption factor may be negligible. Therefore, the light attenuation in fog can be mostly attributed to the scattering factor represented by a scattering coefficient k that is proportionally related to the fog density a. The value of the scattering coefficient k may depend upon the wavelength of the light in addition to the density of the fog. It is noted that the attenuation may generally increase with higher light frequencies (or shorter wavelengths). Thus, the higher the fog density, the higher scattering coefficient k. Further, although the blue light may suffer less attenuation in fog, the human eyes may not tolerate the blue light very well. The sight of the human eyes may become blurry with respect to light beams of very short wavelengths.

Further, the motor vehicle can be operated in different driving modes including a driver mode when operated by a human operator and a self-driving mode when operated without the human operator. In the driver mode, the human eyes may have variable sensitivities to light at different wavelength regions. For example, the human eyes in general may be most sensitive to light waves in a wavelength region around 555 nm of a substantially green color. At night, the sensitivity region of human eyes may be shifted to a wavelength region around 507 nm which is a substantially cyan color. The human eyes commonly are not good receptors of blue lights. In the self-driving mode without a human operator, image sensors are used to monitor the road. In the self-driving mode, the primary concerns are to provide the clear images to the image sensors in different environments.

Because current implementations of light systems on motor vehicles are fixed at a particular wavelength region that is a compromise of different scenarios (e.g., day and night, different fog conditions) for human operators, current light systems do not provide a customized optimal solution for different fog conditions under different driving modes. For example, current light systems use yellow light in the wavelength range of 570 nm to 590 nm for the fog light.

To overcome the above-identified technical issues arise from varying fog conditions and under different driving modes, implementations of the present disclosure may provide technical solutions that may detect the densities of the fog surrounding a motor vehicle and based on the detected fog densities, adjust the wavelength to achieve an optimal visibility for either the driver mode or the self-driving mode.

Implementations of the disclosure may provide an intelligent light system that can be installed on a motor vehicle. The system may include sensors for acquiring sensor data from the environment, a processing device for detecting the conditions of the environment based on the sensor data, and light sources capable of emitting lights with adjustable wavelengths. In one implementation, the sensors are image sensors that may capture images surrounding the motor vehicle at a certain frame rate (e.g., at the video frame rate or at lower than the video frame rate). Responsive to receiving the images captured by the image sensors, the processing device may feed the captured images to a neural network to determine the density of the fog surrounding the motor vehicle. The processing device may, based on the determined fog density and the driving mode, adjust the wavelength of the headlights and/or the fog lights while the vehicle moves on the road, thereby providing optimal visibilities according the fog condition and the driving mode in real time or close to real time.

In another implementation, the sensors can be a global positioning system (GPS) signal generator that may emit the GPS signal to satellites. Based on the GPS signals received by the satellites, a GPS service provider may determine the location of the motor vehicle and provide a location-based weather report to the motor vehicle. An intelligent light system may determine a state of the environment surrounding the motor vehicle. Thus, even if the motor vehicle is not equipped with image sensors for detecting the surrounding environment.

Implementations of the present disclosure may provide a method for operating vehicle-mounted intelligent light system. Implementations may include receiving sensor data captured by sensors, detecting the conditions of the environment based on the sensor data, and causing to adjust wavelengths of lights emitted from a light source of the vehicle based on the conditions and the driving modes. In one specific implementation, the method may include receiving images captured by image sensors mounted on the motor vehicle, executing a neural network based on the captured images to determine the density of the fog in the environment surrounding the motor vehicle, and based on the determined fog density and the driving mode, adjusting the wavelength of the headlights and/or the fog lights, thereby providing optimal visibilities according the fog condition and the driving mode.

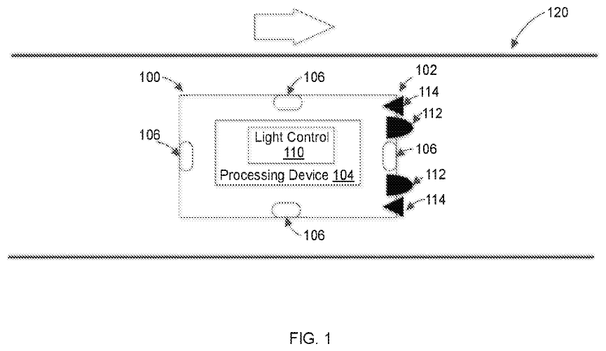

FIG. 1 illustrates a motor vehicle 100 including an intelligent light system according to an implementation of the present disclosure. Referring to FIG. 1, motor vehicle 100 may travel on a road 120 in a certain direction. Motor vehicle 100 can be any types of automobiles that can be operated either by a human operator in the driver mode or operated autonomously in the self-driving mode. In one implementation, motor vehicle 100 may include mechanical and electrical components (not shown) to operate the motor vehicle 100. Relevant to the disclosure, motor vehicle 100 may include a light system 102, a processing device 104, and environmental sensors 106.

Light system 102 may include headlights 112 and fog lights 114 that may be mounted at the front end of motor vehicle 100. Headlights 112 and fog lights 114 when turned on in fog conditions may help improve the visibility for the driver. In one implementation, headlights 112 and fog lights 114 may generate light beams with variable wavelengths. In particular, headlights 112 and fog lights 114 may include light-emitting diodes (LEDs) of different colors (e.g., red, green, blue) that may be combined to generate light beams of different colors.

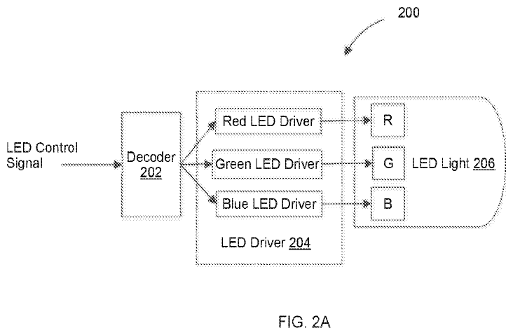

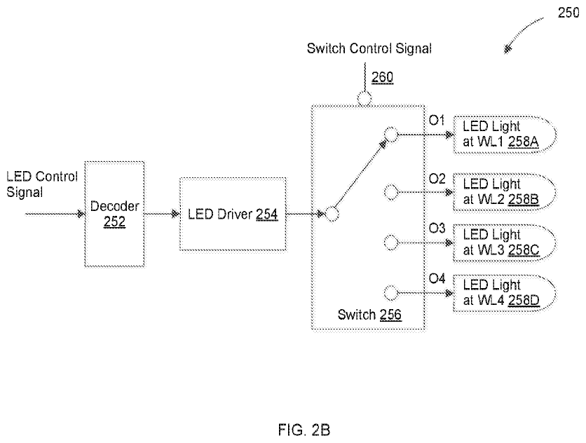

FIG. 2A illustrates a LED light system 200 according to an implementation of the present disclosure. A led-emitting diode is a semiconductor light emitter that produce colored lights when electrical current flows through the diode. Common LED colors include red, green, or blue while other colors can be constructed from the red, green, and blue LEDs. As shown in FIG. 2A, LED light system 200 may include a decoder circuit 202, a LED driver circuit 204, and a LED light 206.

LED decoder circuit 202 may receive a LED control signal from a controller circuit (e.g., processing device 104 as shown in FIG. 1). The LED control signal may contain color information for LED light 206. The color information may be a specific target color. Alternatively, the color information may contain the proportions of red, green, and blue colors that may be combined to form a target color for the LED light 206. Decoder circuit 202 may convert LED control signals to color control signals for LED driver circuit 204. Responsive to receiving color control signals from decoder circuit 202, LED driver circuit 204 may supply the amount currents to red light-emitting diodes, green light-emitting diodes, and blue light-emitting diodes. As shown in FIG. 2A, LED driver circuit 204 may include a red LED driver circuit for controlling the amount of current supplied to red light-emitting diodes of LED light 206, a green LED driver circuit for controlling the amount of current supplied to green light-emitting diodes of LED light 206, and a blue LED driver circuit for controlling the amount of current supplied to the blue light-emitting diodes of LED light 206. In some implementations, the red, green, and blue LED driver circuits can be a voltage amplitude modulation circuit, a pulse width modulation circuit, or a suitable current source regulation circuit.

LED light 206 may include a string of red light-emitting diodes driven by the red LED driver circuit, a string of green light-emitting diodes driven by the green LED driver circuit, and a string of blue light-emitting diodes driven by the blue LED driver circuit. The red, green, and blue light intensities may be controlled by their respective driver circuits. By controlling the amount of currents supplied to the red, green, and blue light-emitting diodes, LED light 206 may generate light beams of different colors, where the color of the generated light may be a weighted combination of red, green, and blue lights. Thus, processing device 104 may control the color of the light beams generated from LED light 206 by regulating the relative amount of currents supplied to red, green, and blue LED drivers. Here, LED light 206 can serve as headlights 112 and/or fog lights 114.

FIG. 2A illustrates a system that may combine three primary-color LED lights to generate an output light. In an alternative implementation, instead of combining LED lights of different primary colors, the light system may include discrete LEDs at different wavelengths that can be selectively enabled. FIG. 2B illustrates a LED light system 250 including discrete LEDs at different wavelengths according to an implementation of the disclosure. As shown in FIG. 2B, LED light system 250 may include a decoder 252, a LED driver circuit 254, a switch circuit 256, and discrete LED lights 258A-258D at different pre-assigned wavelengths. Similar to decoder circuit 202, decoder circuit 252 may generate input signal to LED driver circuit 254. The input signal may include the intensity for the LED driver circuit 254. LED driver circuit 254 may supply the current that drives one of LED light 258A-258D. To this end, switch circuit 256 may be a multiplexer circuit including switch control terminal 260 to receive a switch control signal. The switch control signal may control the input of switch 256 connected to one of the outputs O1-O4, thus connecting to one of the discrete LED lights 258A-258D with different wavelengths. In one implementation, each of discrete LED lights 258A-258D may be selected to generate light associated with a particular wavelength that is beneficial to a particular environmental condition (e.g., a fog condition). For example, LED lights 258A-258D can be associated with wavelengths of 450 nm, 507 nm, 555 nm, and 584 nm, respectively. Thus, when LED driver 254 is switched by switch control signal 260 to be connected to O1, LED driver 254 supplies a current to and activate the LED light at a first wavelength (e.g., around 450 nm) while LED lights at the second, third, and fourth wavelengths are not activated. Similarly, LED driver 254 can be switched to O2, O3, or O4 to activate the corresponding LED light.

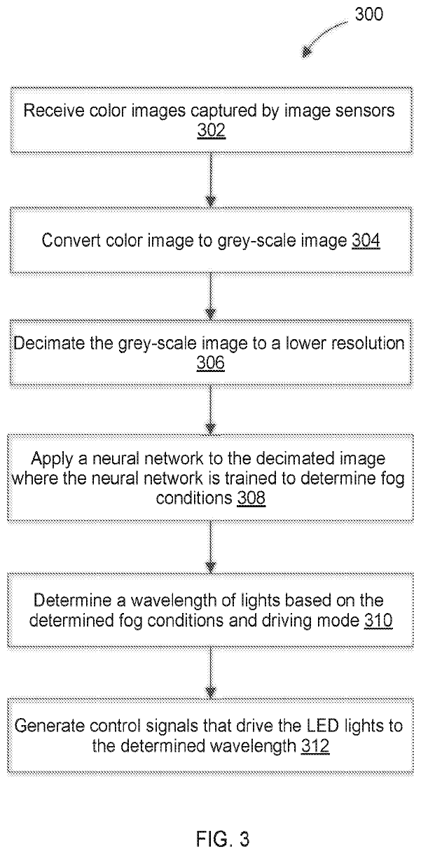

Referring to FIG. 1, image sensors 106 can be video cameras mounted on motor vehicle 100 to capture images from one or more directions including one or more of the front view, the rear view, or the side views. These images may be captured at a video frame rate (e.g., 60 frames per second) or at a frame rate higher or lower than the view frame rate. The processing device 104 can be a hardware processor such as a central processing unit (CPU), a graphic processing unit (GPU), or a neural network accelerator processing unit. Processing device 104 may be communicatively coupled to image sensor 106 to receive image frames captured by image sensors 106. In one implementation, motor vehicle 100 may include a storage device (e.g., a memory or a hard drive) (not shown) that may store the executable code of a light control program 110 that, when executed, may cause processing device 104 to perform the following operations as illustrated in FIG. 3.

FIG. 3 illustrates a flowchart of a method 300 to control a light system according to an implementation of the disclosure. Method 300 may be performed by processing devices that may comprise hardware (e.g., circuitry, dedicated logic), computer readable instructions (e.g., run on a general-purpose computer system or a dedicated machine), or a combination of both. Method 300 and each of its individual functions, routines, subroutines, or operations may be performed by one or more processors of the computer device executing the method. In certain implementations, method 300 may be performed by a single processing thread. Alternatively, method 300 may be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 300 may be performed by a processing device 104 executing light control program 110 as shown in FIG. 1.

The onboard image sensors 106 may continuously capture images of the surrounding environment for processing device 104, where the captured images can be colored image frames. Image sensors 106 can be a digital video camera that captures image frames including an array of pixels. Each pixel may include a red, a green, and a blue component. In some implementations, image sensors 106 can be a high-resolution video camera and the image frame may contain an array of 1280×720 pixels.

At 302, processing device 104 may receive the color image frames captured by image sensors 106, wherein the image frames can include a high-resolution array of pixels with red, green, and blue components.

To reduce the amount of data that need to be processed by a neural network, at 304, processing device 104 may convert the color image into a grey-scale image. In one implementation, processing device 104 may represent each pixel in a YUV format, where Y represents the luminance component (the brightness) and UV are the chrominance components (colors). Instead of using the YUV format, processing device 104 may represent each pixel using only the luminance component Y. In one implementation, the luminance component Y may be quantized and represented using 8 bits (256 grey-levels) for each pixel.

To further reduce the amount of data that need to be processed by the neural network, at 306, processing device 104 may decimate the image array from a high resolution to a low resolution. For example, processing device 104 may decimate the image frames from the original resolution of 1280×720 pixel array to 224×224 pixel array. The decimation may be achieved by sub-sampling or low-pass filtering and then sub-sampling.

At 308, processing device 104 may apply a neural network to the decimated, grey-scale image, where the neural network may have been trained to determine the fog condition in the environment surrounding the motor vehicle 100. The neural network may have been trained on a standard database to determine whether the fog condition is “no fog”, “light fog” or “dense fog”. These fog conditions may be used to determine the colors (or wavelengths) of headlights 112 and/or fog lights 114.

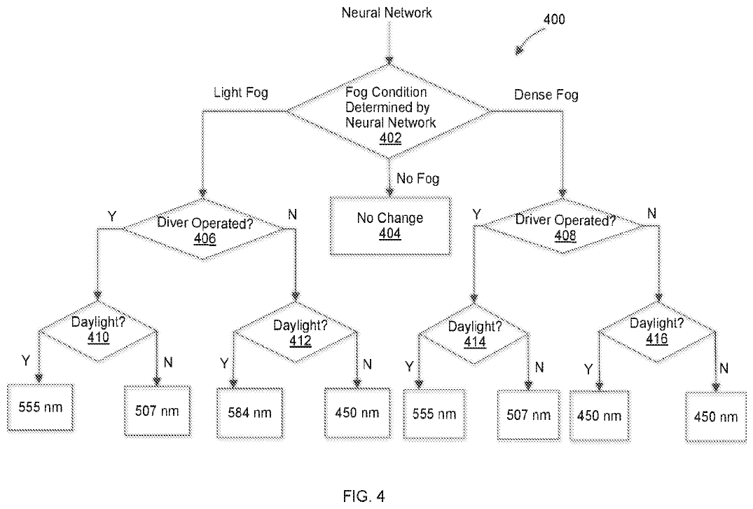

At 310, processing device 104 may further determine the color (or wavelength) of headlights 112 and/or fog lights 114 based on the fog condition and driving mode. In one implementation, processing device 104 may use a decision tree 400 as shown in FIG. 4 to determine the color of the lights.

As shown in FIG. 4, processing device 104 may receive results from neural network and determine the light color using decision tree 400. At 402, processing device 104 may determine the result as one of “no fog”, “light fog” and “dense fog”. Responsive to determining that the result is “no fog,” at 404, processing device 104 may make no change to the light color.

Responsive to determining that the environment is in the light fog condition, at 406, processing device 104 may determine if the motor vehicle is in the driver mode with an operator or self-driving mode without an operator. Responsive to determining that the motor vehicle is in the driver mode, at 410, processing device 104 may determine if the environment is in daylight or in the dark. Responsive to determining that the environment is in light fog and daylight, processing device 104 may determine that the lights (headlights or fog lights) should be green to yellow in a wavelength range around 555 nm; responsive to determining that the environment is in light fog and in the dark, processing device 104 may determine the lights should be cyan in a wavelength range around 507 nm.

Responsive to determining that the motor vehicle is in a self-driving mode, at 412, processing device 104 may determine if the environment is in daylight or in the dark. Responsive to determining that the environment is in light fog and daylight, processing device 104 may determine that the lights should be blue in a wavelength range around 485 nm; responsive to determining that the environment is in light fog and in the dark, processing device 104 may determine the lights should be blue in a wavelength range around 450 nm.

Back to the result from the neural network, responsive to determining that the environment is in dense fog, at 408, processing device may determine if the motor vehicle is in the driver mode with an operator or self-driving mode without an operator. Responsive to determining that the motor vehicle is in the driver mode, at 414, processing device 104 may determine if the environment is in daylight or in the dark. Responsive to determining that the environment is in dense fog and daylight, processing device 104 may determine that the lights should be green to yellow in a wavelength range around 555 nm; responsive to determining that the environment is in dense fog and in the dark, processing device 104 may determine the lights should be cyan in a wavelength range around 507 nm.

Responsive to determining that the motor vehicle is in a self-driving mode, at 416, processing device 104 may determine if the environment is in daylight or in the dark. Responsive to determining that the environment is in dense fog and daylight, processing device 104 may determine that the lights should be blue in a wavelength range around 450 nm; responsive to determining that the environment is in dense fog and in the dark, processing device 104 may determine the lights should be blue in a wavelength range around 450 nm.

In one implementation, a deep learning neural network may be used to determine the colors (wavelengths) of motor vehicle light in fog conditions. The deep learning neural network may be trained directly on pixel values of image frames in a public dataset. The training can be performed offline using the CityScapes dataset which can be modified to different fog conditions. For each original image, three fixed levels of fog effects may be added to it. According to the documentation of the Foggy CityScapes dataset, the three levels correspond to the attenuation factors used to render those fog effects are 0.005, 0.01 and 0.02. Images with an attenuation factor of less than 0.005 are not used because the fog effects are negligible. As a result, each scene in the fog detection dataset has three corresponding images, the original image, the foggy image with an attenuation factor of 0.01, and the foggy image with an attenuation factor of 0.02. A deep learning neural network trained and validated based on CityScape dataset may achieve the detection of no fog, light fog, and dense fog conditions with 98% accuracy. Although the deep learning neural network is trained and tested based on the three environment conditions, it is understood that the deep learning neural network may be trained to determine more than three levels of fog conditions.

Referring to FIG. 3, after determining the light color at 310, at 312, processing device 104 may generate a color control signal to be transmitted to decoder 202 and LED driver circuit 204 that may drive LED light 206 to the target color (or wavelength).

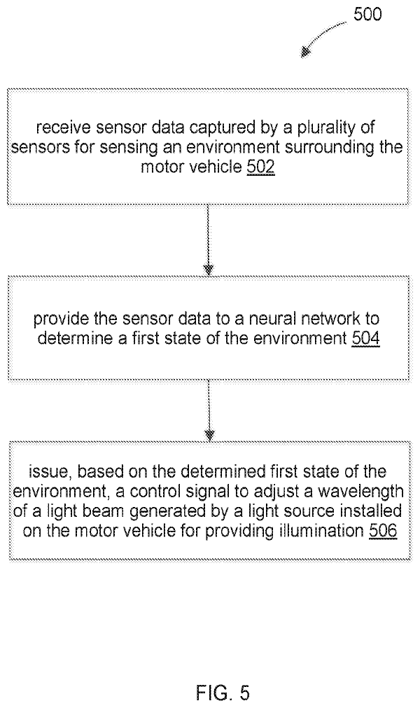

FIG. 5 illustrates a flowchart of a method 500 to control a light system according to an implementation of the disclosure.

At 502, a processing device of an intelligent light system may receive sensor data captured by a plurality of sensors for sensing an environment surrounding the motor vehicle.

At 504, the processing device may provide the sensor data to a neural network to determine a first state of the environment.

At 506, the processing device may issue, based on the determined first state of the environment, a control signal to adjust a wavelength of a light beam generated by a light source installed on the motor vehicle for providing illumination.

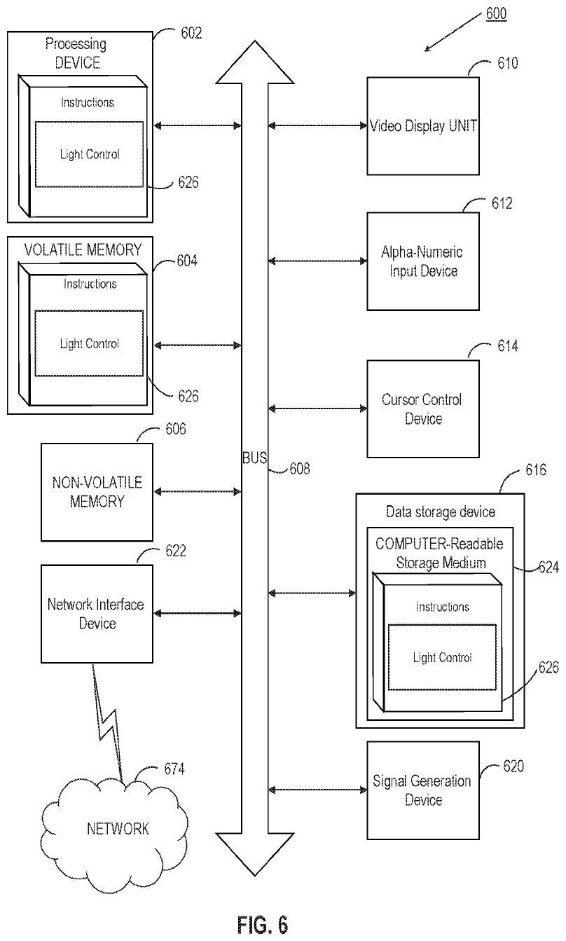

FIG. 6 depicts a block diagram of a computer system operating in accordance with one or more aspects of the present disclosure. In various illustrative examples, computer system 600 may correspond to the processing device 104 of FIG. 1.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620.

Data storage device 616 may include a non-transitory computer-readable storage medium 624 on which may store instructions 626 encoding any one or more of the methods or functions described herein, including instructions of the light control program 110 of FIG. 1 for implementing method 300.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first”, “second”, “third”, “fourth” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. An intelligent light system installed on a motor vehicle, comprising:
a light source to provide illumination for the motor vehicle, wherein a wavelength of a light beam generated by the light source is adjustable;
a plurality of sensors for capturing sensor data of an environment surrounding the motor vehicle; and
a processing device, communicatively coupled to the plurality of sensors and the light source, to:
receive the sensor data captured by the plurality of sensors;
provide the sensor data to a neural network to determine a first state of the environment; and
issue a control signal to adjust the wavelength of the light beam based on the determined first state of the environment.

2. The intelligent light system of claim 1, wherein the light source is one of a headlight or a fog light of the motor vehicle, wherein the one of the headlight or the fog light comprises one or more LED light emitters.

3. The intelligent light system of claim 1, wherein the plurality of sensors comprise a plurality of image sensors that are mounted on the motor vehicle to capture at least one image of a front view, a back view, or a side view of the motor vehicle, and wherein the plurality of sensors comprise a global positioning system (GPS) sensor to provide a location of the motor vehicle.

4. The intelligent light system of claim 3, wherein to determine a first state of the environment surrounding the motor vehicle, the processing device is further to:
determine a fog condition surrounding the motor vehicle;
determine a driving mode of the motor vehicle, wherein the driving mode comprises a driver mode and a self-driving mode;
determine a time mode, wherein the time mode comprises a daylight mode and a night mode; and
determine the first state based on at least one of the determined fog condition, the determined driving mode, or the time mode.

5. The intelligent light system of claim 4, wherein the fog condition comprises a fog-free condition, a light fog condition, and a heavy fog condition.

6. The intelligent light system of claim 5, wherein to determine the first state of the environment, the processing device is further to:
receive the at least one image captured by the plurality of image sensors;
convert the at least one image to a grey-scale image;
decimate the grey-scale image from a first spatial resolution to a second spatial resolution; and
apply the neural network to the decimated grey-scale image to determine the first state of the environment.

7. The intelligent light system of claim 6, wherein the processing device is further to:
determine, using a decision tree, the wavelength of the light beam generated by the light source based on the determined first state of the environment; and
generate and issue the control signal based on the wavelength.

8. The intelligent light system of claim 7, wherein the processing device is further to:
provide a GPS signal to a weather service provider;
receive, from the weather service provider, the fog condition determined based on the location of the motor vehicle determined using the GPS signal; and
determine the first state based on the fog condition.

9. The intelligent light system of claim 7, further comprising:
a decoder circuit to receive the control signal and decode the control signal into one or more current intensity values; and
a driver circuit to generate one or more currents based on the one or more current intensity values, and to drive the one or more LED light emitters.

10. The intelligent light system of claim 7, further comprising:
a decoder circuit to receive the control signal and decode the control signal into a current intensity value;
a driver circuit to generate a current based on the current intensity value; and
a switch circuit to receive the current and selectively supply the current, based on a switch control signal, to one of a plurality of output pins, wherein the switch control signal is determined by the first state, and each one of the plurality of output pins is connected to a respective LED emitter for emitting an LED light of a corresponding wavelength.

11. The intelligent light system of claim 1, wherein responsive to detecting that the motor vehicle moves to a second location, the processing device is to:
receive second sensor data captured by the plurality of sensors;
provide the sensor data to the neural network to determine a second state of the environment at the second location; and
issue a second control signal to adjust the wavelength of the light beam based on the determined second state of the environment.

12. A method for operating an intelligent light system installed on a motor vehicle, the method comprising:
receiving sensor data captured by a plurality of sensors for sensing an environment surrounding the motor vehicle;
providing, by a processing device, the sensor data to a neural network to determine a first state of the environment; and
issuing, based on the determined first state of the environment, a control signal to adjust a wavelength of a light beam generated by a light source installed on the motor vehicle for providing illumination.

13. The method of claim 12, wherein the light source is one of a headlight or a fog light of the motor vehicle, wherein the one of the headlight or the fog light comprises one or more LED light emitters.

14. The method of claim 12, wherein the plurality of sensors comprise a plurality of image sensors that are mounted on the motor vehicle to capture at least one image of a front view, a back view, or a side view of the motor vehicle, and wherein the plurality of sensors comprise a global positioning system (GPS) sensor to provide a location of the motor vehicle.

15. The method of claim 14, wherein determining a first state of the environment comprises:
determining a fog condition surrounding the motor vehicle, wherein the fog condition comprises a fog-free condition, a light fog condition, and a heavy fog condition;
determining a driving mode of the motor vehicle, wherein the driving mode comprises a driver mode and a self-driving mode;
determining a time mode, wherein the time mode comprises a daylight mode and a night mode; and
determining the first state based on at least one of the determined fog condition, the determined driving mode, or the time mode.

16. The method of claim 15, wherein determining a first state of the environment comprises:
receiving the at least one image captured by the plurality of image sensors;
converting the at least one image to a grey-scale image;
decimating the grey-scale image from a first spatial resolution to a second spatial resolution; and
applying the neural network to the decimated grey-scale image to determine the first state of the environment.

17. The method of claim 16, further comprising:
determining, using a decision tree, the wavelength of the light beam generated by the light source based on the determined first state of the environment; and
generating and issuing the control signal based on the wavelength.

18. The method of claim 17, further comprising:
decoding, by a decoder circuit, the control signal into one or more current intensity values;
generating, by a driver circuit, one or more currents based on the one or more current intensity values; and
providing the one or more currents to drive the one or more LED light emitters.

19. The method of claim 17, further comprising:
decoding, by a decoder circuit, the control signal into a current intensity value;
generating, by a driver circuit, a current based on the current intensity value; and
receiving, by a switch circuit, the current and selectively supply the current, based on a switch control signal, to one of a plurality of output pins, wherein the switch control signal is determined by the first stage, and each one of the plurality of output pins is connected to a respective LED emitter for emitting an LED light of a corresponding wavelength.

20. A non-transitory machine-readable storage medium storing instructions which, when executed, cause a processing device to operations of an intelligent light system installed on a motor vehicle, the operations comprising:
receiving sensor data captured by a plurality of sensors for sensing an environment surrounding the motor vehicle;
providing, by a processing device, the sensor data to a neural network to determine a first state of the environment; and
issuing, based on the determined first state of the environment, a control signal to adjust a wavelength of a light beam generated by a light source installed on the motor vehicle for providing illumination.
